(19) United States
(12) Patent Application Publication
(10) Pub. No.: US 2005/0272850 A1
(43) Pub. Date: Dec. 8, 2005

(54) Process for the preparation of rubber extender oil compositions

(76) Inventors: Yajnanarayana Halmuthur Jois, Katy, TX (US); Michael Phillip Smith, The Woodlands, TX (US); John Robert Powers, Kingwood, TX (US)

Correspondence Address: SHELL OIL COMPANY, P O BOX 2463, HOUSTON, TX, 772522463, US

(21) Appl. No.: 10/860,219

(22) Filed: Jun. 3, 2004

(51) Int. Cl. C08L 1/00

(52) U.S. Cl. 524/484; 524/485; 524/486; 524/491; 524/848

(57) ABSTRACT

A process for the preparation of a rubber extender oil composition having a polynuclear aromatics content of at most 3 wt. % (IP346) is provided. A hydrotreated paraffinic base oil having a polynuclear aromatics content of at most 3 wt. % is blended with a hydrotreated naphthenic base oil having a polynuclear aromatics content of at most 3 wt. %.

### FIELD OF THE INVENTION

The present invention relates to a process for the production of rubber extender oil compositions and rubber compositions produced therefrom.

### BACKGROUND OF THE INVENTION

Rubber extender oil compositions are added to natural and synthetic rubbers for a number of reasons, for example to reduce the mixing temperature required during processing and to prevent the scorching of the rubber polymer when it is being ground, to decrease the viscosity of the rubber to improve the general workability of the rubber compound, to aid in the dispersion of fillers, to modify the physical properties of the rubber compound, and for other reasons. Generally, the oil used in rubber extender applications has been a mineral oil with high viscosity, low volatility and high solvency for the rubber compound.

Oil compositions must have a certain degree of miscibility and/or solvency with the rubber compounds to be useful as rubber extender oil compositions. The degree of miscibility and/or solvency required will vary depending upon the nature of the rubber compound and intended use of the rubber composition. For rubber compounds containing largely aromatic groups, such as styrene-butadiene rubber (SBR), a highly aromatic rubber extender oil composition is usually employed.

These highly aromatic rubber extender oil compositions, also known as distillate aromatic extracts (DAE), have very high aromatic contents, typically at least 70 wt. %. By the term “aromatic” it is meant a molecule composed primarily of carbon and hydrogen which comprises at least one ring which composed of conjugated unsaturated carbon bonds, such as compounds containing a benzene moiety, polynuclear aromatics or polyaromatic compounds, i.e. compounds comprising more than one aromatic ring fused together, such as anthracene based moieties, are also included in this definition of aromatic. At present, these highly aromatic rubber extender oil compositions are obtained as a by-product of the process of solvent extraction of vacuum distillates used as a raw material for the manufacture of lubricant base oils. These DAEs typically have good compatibility with SBR and other rubber compounds, however, they generally contain high concentrations of polynuclear aromatics, typically from 10 to 15 wt. %. Certain polynuclear aromatics (PNA), also known as higher aromatic rings, polycyclic aromatic (PCA) and poly aromatic hydrocarbons (PAH), are known carcinogens.

Rubber extender oil compositions having greater than 3 wt. % (IP346) polynuclear aromatics are classified as “carcinogenic” according to the European legislation (EU Substance Directive 67/548/EEC) and must be labeled with the risk phrase “R45” (may cause cancer) and the label “T” (toxic, skull and crossbones) in Europe. From the viewpoint of health, safety and environmental impact, it is desired to produce an alternative to distillate aromatic extracts for use as a rubber extender oil composition, which contains at most 3 wt. % (IP346) polynuclear aromatics, and therefore has low carcinogenicity.

The use of rubber extender oil compositions having a polynuclear aromatics content of at most 3 wt. % (IP346) in the production of automotive tires is of special importance, since PNAs are released into the environment in significantly higher quantities due to tire wear compared with that found in the exhaust gas produced by modern passenger cars. There is therefore a need for a replacement rubber extender oil composition having at most 3 wt. % PNA (IP346), wherein the properties of the rubber extender oil composition are such that major reformulation of the rubber compounds used in automotive tires is not required.

Treated distillate aromatic extract (TDAE) have been proposed as replacement compositions for rubber extender oil compositions. Treated distillate aromatic extract has been found to be suitable as a rubber extender oil composition for several rubber compounds and applications. Treated distillate aromatic extracts are manufactured from DAE by further severe processing, such as hydrotreating or solvent extraction, to lower the concentration of PNA to below the threshold of 3 wt. % (IP346). However, the increasing demand in the lubricants market for hydrotreated base oils (API category II) for automotive and industrial applications will significantly change the base oil refining structure. This will affect the future availability of distillate aromatic extract, which is used as the feedstock for the manufacture of treated distillate aromatic extract. These changes are already occurring in the USA and the Far East.

Mildly or medium extracted solvate (MES) is a processed paraffinic vacuum distillate fraction, wherein the aromatic content is kept as high as possible, but the PNA content is below the threshold of 3 wt. % (IP346). Automotive tires using MES are available on the market. MES compositions useful for tire compositions have been disclosed in the article by V. Null “Safe process oils for tires with low environmental impact” (KGK Kautschuk Gunmi Kunststoffe 52, Jahrgang, Nr. 12/99).

The manufacture of rubber extender oil compositions having a polynuclear aromatics content of at most 3 wt. % (IP346) typically requires the use of additional finishing processes and/or the use of specialized process equipment, and therefore the cost of manufacture of the rubber extender oil composition is increased and/or a large capital investment is required for the manufacture of the rubber extender oil composition. It is therefore desirable to develop a simplified process for the production of a rubber extender oil composition having a polynuclear aromatics content of at most 3 wt. % (IP346).

### SUMMARY OF THE INVENTION

In accordance with one embodiment of the invention, there is provided a process for the preparation of a rubber extender oil composition having a polynuclear aromatics content of at most 3 wt. % (IP346). The process for the preparation of a rubber extender oil composition having a polynuclear aromatics content of at most 3 wt. % (IP346), comprises blending a hydrotreated paraffinic base oil having a polynuclear aromatics content of at most 3 wt. % (IP346) and a hydrotreated naphthenic base oil having a polynuclear aromatics content of at most 3 wt. % (IP346).

In another embodiment of the invention, a rubber extender oil composition having a polynuclear aromatics content of at most 3 wt. %, is prepared by a process comprising blending a hydrotreated paraffinic base oil having a polynuclear aromatics content of at most 3 wt. % and a hydrotreated naphthenic base oil having a polynuclear aromatics content of at most 3 wt. % in a ratio of from 1:20 to 20:1 by weight.

In another embodiment of the invention, a process for the preparation of a rubber extender oil composition having a polynuclear aromatics content of at most 3 wt. %, an aromatic content of at least about 25 wt. %, an aniline point in the range of from about 90 to about 110° C., a glass transition point in the range of from −70 to −20° C., and a viscosity in the range of from about 12 to about 17 cSt at 100° C. is provided, comprising blending a hydrotreated paraffinic base oil having a polynuclear aromatics content of at most 3 wt. % and a hydrotreated naphthenic base oil having a polynuclear aromatics content of at most 3 wt. %.

Yet in another embodiment of the invention, a process for the preparation of a rubber extender oil composition having a polynuclear aromatics content of at most 3 wt. %, an aromatic content of at least about 25 wt. %, an aniline point in the range of from about 90 to about 110° C., a glass transition point in the range of from −70 to −20° C., and a viscosity in the range of from about 12 to about 17 cSt at 100° C. is provided comprising blending a hydrotreated paraffinic base oil having a polynuclear aromatics content of at most 3 wt. % and a hydrotreated naphthenic base oil having a polynuclear aromatics content of at most 3 wt. % in a ratio in the range of from 1:20 to 20:1 by weight.

Yet in another embodiment of the invention, a process for the preparation of a rubber extender oil composition having a polynuclear aromatics content of at most 3 wt. % is provided, comprising blending a hydrotreated paraffinic base oil having a polynuclear aromatics content of at most 3 wt. % and a hydrotreated naphthenic base oil having a polynuclear aromatics content of at most 3 wt. %, wherein the flash point of the hydrotreated paraffinic base oil is at least 235° C.

In another embodiment of the invention, a process for the preparation of a rubber extender oil composition having a polynuclear aromatics content of at most 3 wt. %, comprising blending a hydrotreated paraffinic base oil having a polynuclear aromatics content of at most 3 wt. % and a hydrotreated naphthenic base oil having a polynuclear aromatics content of at most 3 wt. % is provided, wherein the hydrotreated paraffinic base oil has an aromatic content of at least 5 wt. %, an aniline point of at most 130° C. and a viscosity of at least 11.0 cSt at 100° C.

In yet another embodiment of the invention, a process for the preparation of a rubber extender oil composition having a polynuclear aromatics content of at most 3 wt. %, comprising blending a hydrotreated paraffinic base oil having a polynuclear aromatics content of at most 3 wt. % and a hydrotreated naphthenic base oil having a polynuclear aromatics content of at most 3 wt. %, wherein the flash point of the hydrotreated naphthenic base oil is at least 235° C.

In another embodiment of the invention, there is provided a rubber composition comprising a rubber and/or rubber components, and a rubber extender oil composition produced by the process of the present invention in the range of from about 0.5 wt. % to about 50 wt. % based on the weight of the rubber composition.

In yet another embodiment of the invention, a rubber composition is provided comprising:
a) at least one rubber, rubber component, or mixtures thereof,
b) a rubber extender oil composition produced by the process of the present invention in the range of from 0.5 wt. % to 50 wt. % based on the weight of the rubber composition, and optionally at least one component selected from:
c) reinforcing agents,
d) cross-linking agents and/or cross-linking auxiliaries,
e) inorganic fillers, and
f) waxes and/or antioxidants.

### DETAILED DESCRIPTION OF THE INVENTION

The process of the present invention may be used to prepare process oils and rubber extender oil compositions. All of the characteristics described herein for the rubber extender oil composition produced by the process of the present invention may be applied to process oils. Process oils produced by the process of the present invention are useful in, for example, ink production, wood preservatives, in particular those used in pole treating, and as a rubber extender oil composition for products such as tires. The process oil composition produced by the process of the present invention is particularly useful as a rubber extender oil composition.

The process of the present invention comprises blending a hydrotreated paraffinic base oil having a polynuclear aromatics content of at most 3 wt. % (IP346) and a hydrotreated naphthenic base oil having a polynuclear aromatics content of at most 3 wt. % (IP346) to produce a process oil. In particular, the process of the present invention comprises blending a hydrotreated paraffinic base oil having a polynuclear aromatics content of at most 3 wt. % (IP346) and a hydrotreated naphthenic base oil having a polynuclear aromatics content of at most 3 wt. % (IP346) to produce a rubber extender oil composition.

The rubber extender oil composition produced by the process of the present invention has at most 3 wt. % content of polynuclear aromatics as measured according to The Institute of Petroleum 346 (IP346) test method. The advantage of having a concentration of at most 3 wt. % (IP346) PNAs is that the rubber extender oil composition has an advantageously low carcinogenicity, and as such avoids the need to be labeled as a class 2 carcinogen in the European Union or potentially hazardous under current U.S. OSHA regulations.

A high aromatic content is desired for rubber extender oil compositions, since this increases the solvency of the rubber extender oil composition for rubber compounds containing largely aromatic groups, such as styrene-butadiene rubber. Therefore, the aromatic content of the rubber extender oil composition produced by the process of the present invention is preferably high. Preferably, the aromatic content of the rubber extender oil composition produced by the process of the present invention will be at least about 25 wt. %, more preferably at least about 30 wt. % according to Clay-Gel analysis (ASTM test method D2007). Preferably, the aromatic content of the rubber extender oil composition produced by the process of the present invention will be at most about 90 wt. %. In one embodiment of the present invention, the rubber extender oil composition produced by the process of the present invention will have an aromatic content of at most about 50 wt. % (ASTM test method D2007).

The aniline point of rubber extender oil compositions can be used to indicate the level of solvency with rubber compounds, in particular a low aniline point (less than about 110° C. according to ASTM test method D611) is indicative of high solvency for rubber extender applications. Therefore, the aniline point of the rubber extender oil composition produced by the process of the present invention is preferably within the range useful for rubber extender oil applications known to those skilled in the art. Preferably, the aniline point will be in the range of from about 90° C. to about 110° C. (ASTM test method D611).

The viscosity of the rubber extender oil composition produced by the process of the present invention should be in the range preferred for use as a rubber extender oil. Preferably, the viscosity of the rubber extender oil composition is in the range of from about 12 cSt to about 17 cSt (about 1.2×10⁻⁵ to about 1.7×10⁻⁵ m²s⁻¹) at 100° C. according to ASTM test method D445. Preferably, the rubber extender oil composition should also have a viscosity in the range of from about 140 cSt to about 190 cSt (about 1.4×10⁻⁴ to about 1.9×10⁻⁴ m²S⁻¹) at 40° C. according to ASTM test method D445.

The flash point of a rubber extender oil composition should be kept reasonably high. Preferably, the rubber extender oil composition produced by the process of the present invention should have a flash point of at least 235° C., more preferably at least 240° C. (Cleveland Open Cup, ASTM test method D92). Most preferably, the flash point of the rubber extender oil composition is in the range of from 240° C. to 300° C., especially in the range of from 240° C. to 275° C. (ASTM test method D92).

The glass transition point (Tg) of the rubber extender oil composition produced by the process of the present invention should be within the range useful for rubber extender applications known to those skilled in the art. Preferably, the glass transition point of the rubber extender oil will be in the range of from −70° C. to −20° C. according to ASTM test method E1356. More preferably, the glass transition point of the rubber extender oil will be in the range of from −70° C. to −40° C., even more preferably in the range of from −70° C. to −50° C. (ASTM test method E1356).

The pour point of the rubber extender oil composition produced by the process of the present invention should be within the range useful for rubber extender applications known to those skilled in the art. Preferably, the pour point of the rubber extender oil is at most about −8° C. or lower according to ASTM test method D5950.

The specific gravity of the rubber extender oil composition produced by the process of the present invention should be within the range useful for rubber extender applications. Preferably, the specific gravity of the rubber extender oil will be in the range of from about 0.89 to about 0.93 at 15.56° C. (60° F.) according to ASTM test method D4052.

In one preferred embodiment, there is provided a process for the production of a rubber extender oil composition having a polynuclear aromatics content of at most 3 wt. % (IP346), an aromatic content of at least about 30 wt. % (ASTM test method D2007), an aniline point of from about 90 to about 110° C. (ASTM test method D611), a glass transition point is from −70 to −20° C. (ASTM test method E1356), a viscosity of from about 12 to about 17 cSt (about 1.2×10⁻⁵ to about 1.7×10⁻⁵ m²s⁻¹) at 100° C. (ASTM test method D445), a flash point of from 240 to 300° C. (ASTM test method D92) and a pour point of about −8° C. or lower (ASTM test method D5950), which comprises blending a hydrotreated paraffinic base oil having a polynuclear aromatics content of at most 3 wt. % (IP346) and a hydrotreated naphthenic base oil having a polynuclear aromatics content of at most 3 wt. % (IP346).

The process of the present invention requires the blending of certain hydrotreated paraffinic base oil with certain hydrotreated naphthenic base oil to produce a rubber extender oil composition having the desired characteristics as described above. The method by which the blending occurs can be by any suitable blending process known in the art. Preferably, blending of the hydrotreated paraffinic base oil and the hydrotreated naphthenic base oil is performed by a mechanical stirring method.

In one aspect of the present invention, the blending of the hydrotreated paraffinic base oil and the hydrotreated naphthenic base oil is performed using mechanical stirring at a temperature in the range of from about 10 to about 100° C., more preferably in the range of from about 50 to about 80° C. In another aspect of the present invention, the rubber extender oil composition is produced by blending the hydrotreated paraffinic base oil and the hydrotreated naphthenic base oil in-situ during the preparation of the rubber composition. In another aspect of the present invention, the rubber extender oil composition is produced by blending the hydrotreated paraffinic base oil and the hydrotreated naphthenic base oil prior to inclusion in the rubber composition.

The blending of the hydrotreated paraffinic base oil and the hydrotreated naphthenic base oil may conveniently be performed below the flash point of the hydrotreated paraffinic base oil and the hydrotreated naphthenic base oil. Preferably, the blending is performed at a temperature in the range of from about 0° C. to about 200° C. The blending process may very conveniently be performed at about room temperature. In one aspect of the present invention, the blending process is performed at a temperature in the range of from about 10 to about 100° C., preferably in the range of from about 50 to about 80° C. The pressure which the blending process is performed under is not critical, and may be performed under vacuum conditions or extreme pressures. Preferably the blending process of the present invention is performed under a pressure in the range of from about 0 atm (0 bar) to about 100 atm (101.325 bar). The blending process may very conveniently be performed at about atmospheric pressure.

The ratio of hydrotreated paraffinic base oil and hydrotreated naphthenic base oil used in the process of the present invention may vary according to the desired characteristics of the rubber extender oil composition and the characteristics of the hydrotreated paraffinic base oil and the hydrotreated naphthenic base oil. Preferably, the hydrotreated paraffinic base oil and hydrotreated naphthenic base oil are blended in a ratio in the range of from about 20:1 to about 1:20 by weight. More preferably, the ratio of hydrotreated paraffinic base oil to hydrotreated naphthenic base oil is in the range of from about 2:1 to about 1:20, most preferably in the range of from about 1:1 to about 1:19.

The feedstock compositions for the process of the present invention can be hydrotreated lubricant base oil compositions produced at lubricant refineries. One advantage of the process of the present invention is that no post blending processes, such as clay filtering, dewaxing, deasphalting, hydrotreating or solvent extraction are required to produce the desired rubber extender oil composition. Although not required, if desired a post-blending process or “finishing step”, such as clay filtering, dewaxing, deasphalting, hydrotreating, solvent extraction or combinations thereof, may be performed.

In one embodiment of the process of the present invention, no additional post-blending processes are performed. The lack of post-blending processes ensures that the process of the present invention is extremely cost effective, since the process of the present invention does not require any additional costs for performing such post-blending processes.

A further advantage of the process of the invention is that no specialized processing equipment is required for the process of the present invention. The only equipment requirements are the blending apparatus. Therefore, not only is the initial capital investment required minimal, the process of the present invention is not limited to being performed within a refinery, but may also be performed at any suitable location, such as the location where the rubber extender oil composition is to be used, a separate process facility, or whilst in transit between locations.

The hydrotreated paraffinic base oil and hydrotreated naphthenic base oil used in the process of the present invention, are hydrotreated paraffinic base oil having a polynuclear aromatics content of at most 3 wt. % (IP346) and hydrotreated naphthenic base oil having a polynuclear aromatics content of at most 3 wt. % (IP346).

Hydrotreated paraffinic base oils are produced as a product fraction in the production of lubricant base oils, and are readily available.

The aromatic content of the rubber extender oil product composition can be varied by selecting a hydrotreated naphthenic base oil with an appropriate aromatic content for producing a rubber extender oil product composition having the desired aromatic content and/or varying the blend ratio of the hydrotreated paraffinic base oil and the hydrotreated naphthenic base oil. In one embodiment of the process of the present invention, the hydrotreated paraffinic base oil has an aromatic content of at least 5 wt. % (ASTM test method D2007).

The hydrotreated paraffinic base oil used in the process of the present invention will have a relatively low aniline point, typically less than about 150° C. (ASTM test method D611). Preferably, the hydrotreated paraffinic base oil will have an aniline point of at most about 130° C., more preferably at most about 125° C. (ASTM test method D611).

The hydrotreated paraffinic base oil used in the process of the present invention should preferably have a flash point of at least 235° C. (ASTM test method D92). More preferably, the hydrotreated paraffinic base oil will have a flash point of at least 240° C. (ASTM test method D92).

The viscosity of the paraffinic base oil used in the process of the present invention should preferably be at least about 11.0 cSt (about 1.1×10⁵ m²s⁻¹) at 100° C., more preferably at least about 11.5 cSt (about 1.15×10⁻⁵ m²s⁻¹) at 100° C. (ASTM test method D445). Preferably, the paraffinic base oil should also have a viscosity of at least about 100 cSt (about 1.0×10⁻⁴ m²s⁻¹) at 40° C. (ASTM test method D445).

Hydrotreated naphthenic base oils are produced as a product fraction in the production of lubricant base oils, and are readily available, especially in the USA.

The aniline point of the hydrotreated naphthenic base oil must be such that the aniline point of the rubber extender oil composition produced by the process of the present invention is within the range useful for rubber extender oil applications known to those skilled in the art. Preferably, the hydrotreated naphthenic base oil will have an aniline point of at most about 110° C. (ASTM test method D611).

The hydrotreated naphthenic base oil used in the process of the present invention should preferably have a flash point of at least 235° C. (ASTM test method D92). More preferably, the hydrotreated naphthenic base oil will have a flash point of at least 240° C. (ASTM test method D92).

The viscosity of the hydrotreated naphthenic base oil used in the process of the present invention is advantageously greater than the hydrotreated paraffinic base oil with which it is to be blended. Preferably, the hydrotreated naphthenic base oil has a viscosity of at least about 15 cSt (about 1.5×10⁻⁵ m²s⁻¹) at 100° C. (ASTM test method D445), more preferably at least about 15.5 cSt (about 1.55×10⁻⁵ m²s⁻¹) at 100° C. (ASTM test method D445). In one embodiment of the present invention, the hydrotreated naphthenic base oil has a viscosity of at least about 15 cSt (about 1.5×10⁻⁵ m²s⁻¹) at 100° C. (ASTM test method D445), preferably at least about 15.5 cSt (about 1.55×10⁻⁵ m²s⁻¹) at 100° C. (ASTM test method D445), and has a viscosity greater than the viscosity of the hydrotreated paraffinic base oil (at 100° C., ASTM test method D445).

The process of the present invention is preferably used to produce a rubber extender oil composition having a polynuclear aromatics content of at most 3 wt. % (IP346), an aromatic content of at least 30 wt. % (ASTM test method D2007), an aniline point in the range of from about 90 to about 110° C. (ASTM test method D611), a glass transition point is in the range of from −70 to −20° C. (ASTM test method E1356), a viscosity in the range of from about 12 to about 17 cSt (about 1.2×10⁻⁵ to about 1.7×10⁻⁵ m²s⁻¹) at 100° C. (ASTM test method D445), a flash point in the range of from 240 to 275° C. (ASTM test method D92) and a pour point of about −8° C. or lower (ASTM test method D5950).

Preferably the hydrotreated paraffinic base oil used in the process of the present invention is a hydrotreated paraffinic base oil having a polynuclear aromatics content of at most 3 wt. % (IP346), a flash point of at least 235° C. (ASTM test method D92), an aromatic content of at least 5 wt. % (ASTM test method D2007), an aniline point of at most about 130° C. (ASTM test method D611) and a viscosity of at least about 11.0 cSt (about 1.1×10⁻⁵ m²s⁻¹) at 100° C. (ASTM test method D445).

Preferably the hydrotreated naphthenic base oil used in the process of the present invention is a hydrotreated naphthenic base oil having a polynuclear aromatics content of at most 3 wt. % (IP346), a flash point of at least 235° C. (ASTM test method D92), an aniline point of at most about 110° C. (ASTM test method D611) and a viscosity of at least about 15.0 cSt (about 1.5×10⁻⁵ m²s⁻¹) at 100° C. (ASTM test method D445).

The rubber extender oil composition produced by the process of the present invention is suitably used in the preparation of rubber compositions. The rubber extender oil composition produced by the process of the present invention is suitably incorporated into a rubber composition in a proportion in the range of from about 0.5 wt. % to about 50 wt. % based on the weight of the rubber composition, by the term “based on the weight of the rubber composition” it is meant based on the weight of the final rubber composition. Since the rubber extender oil composition produced by the process of the present invention comprises at most 3 wt. % PNAs (IP346), rubber composition produced using such rubber extender oil compositions has advantageously low carcinogenicity.

The rubber composition of the present invention comprises:
a) rubber and/or rubber components, and
b) a rubber extender oil composition produced by the process of the present invention in the range of from about 0.5 wt. % to about 50 wt. % based on the weight of the rubber composition. Preferably, wherein a rubber extender oil composition produced by the process of the present invention is incorporated in the range of from about 5 wt. % to about 40 wt. % based on the weight of the rubber composition. The rubber extender oil composition of the present invention may be produced by blending the hydrotreated paraffinic base oil and the hydrotreated naphthenic base oil either prior to addition to the rubber and/or rubber components, or in-situ during the process of making the rubber composition, preferably the hydrotreated paraffinic base oil and the hydrotreated naphthenic base oil are blended to produce the rubber extender oil composition of the present invention prior to addition to the rubber and/or rubber components.

The method of making or compounding a rubber composition comprises mixing a rubber extender oil composition produced by the process of the present invention with a rubber or rubber compound and/or one or more monomer precursors of the rubber or rubber compound in any order. If the rubber extender oil composition is mixed with a rubber or rubber compound, the rubber or rubber compound will preferably be in a crumb, pellet and/or powder form.

The rubber extender oil composition produced by the process of the present invention may be added to the rubber or rubber compound when it is being ground in a mixer in order to prevent “scorching” or “burning” of the rubber or rubber compound particles by the shearing action of the mixer. In another aspect of the present invention, the rubber extender oil composition of the present invention may be prepared in-situ whilst the rubber or rubber compound is being ground in a mixer in order to prevent “scorching” or “burning” of the rubber or rubber compound particles by the shearing action of the mixer. The rubber extender oil composition produced by the process of the present invention may be added to the monomer mix before it is polymerized into the rubber. In another aspect of the present invention, the rubber extender oil composition of the present invention may be prepared in-situ in the monomer mix before it is polymerized into the rubber compound.

The rubber extender oil composition produced by the process of the present invention may be used in synthetic rubbers, natural rubber and mixtures thereof. Examples of synthetic rubbers for which the rubber extender oil composition produced by the process of the present invention is suitable for include, but is not limited to, styrene-butadiene copolymers (SBR), polybutadiene (BR), polyisoprene (IR), polychloroprene (CR), ethylene-propylene-diene ternary copolymers (EPDM), acrylonitrile-butadiene rubber (NBR), butyl rubber (IIR) and the like.

In one embodiment of the present invention, the rubber composition of the present invention comprises:
a) rubber and/or rubber components,
b) a rubber extender oil composition produced by the process of the present invention in the range of from 0.5 wt. % to 50 wt. % based on the weight of the rubber composition, and optionally one or more components selected from:
c) reinforcing agents,
d) cross-linking agents and/or cross-linking auxiliaries,
e) inorganic fillers,
f) waxes and/or antioxidants.

Other compounding agents used in the rubber industry, such as tackifiers, vulcanization controlling agents, high loss-providing agents and low loss-providing agents, may also be optionally included in the rubber composition.

Examples of reinforcing agents are carbon black and silica. Examples of cross-linking agents and cross-linking auxiliaries are organic peroxides, sulfur and organic sulfur compounds as cross-linking agents, and thiazole compounds and guanidine compounds as the cross-linking auxiliaries. Examples of inorganic fillers are calcium carbonate, magnesium carbonate, clay, alumina, aluminium hydroxide, mica and the like. Any suitable waxes and/or antioxidants may be incorporated in order to prevent or reduce degradation.

The method of making the rubber composition of the present invention comprises the blending of the components of the rubber composition, components a) to f), in any order. The conditions used in the preparation of the rubber compositions of the present invention are known to those skilled in the art.

In one aspect of the present invention, the rubber composition comprises components a) and b) only.

The rubber composition of the present invention may, by way of a non-limiting example, be prepared by the following process. A pressure reactor is charged with 1500 g of dried cyclohexane, 100 g of styrene and 150 g of butadiene. The reactor temperature is set to 50° C., and 75 mmol of tetrahydrofuran is added as a randomizer. The polymerization is initiated by the addition of 1.5 mmol of n-BuLi (added in the form of a 1.6 M n-hexane solution of n-BuLi). The polymerization is allowed to proceed for approximately 2 hours at 50° C. The polymerization reaction is terminated by the addition of 0.5 g butylated hydroxy toluene (2,6-di-tert-butyl-4-methyl phenol) in 5 ml of isopropanol. The rubber extender oil of the present invention is subsequently added to the reactor contents in an amount of about 25 wt. % based on the weight of the polymer produced. The reactor contents are then dried by conventional means to obtain the extended synthetic rubber composition.

While the invention is susceptible to various modifications and alternative forms, specific embodiments thereof are shown by way of examples herein described in detail. It should be understood, that the detailed description thereto are not intended to limit the invention to the particular form disclosed, but on the contrary, the intention is to cover all modifications, equivalents and alternatives falling within the spirit and scope of the present invention as defined by the appended claims. The present invention will be illustrated by the following illustrative embodiment, which is provided for illustration only and is not to be construed as limiting the claimed invention in any way.

### EXAMPLES

In all examples, a hydrotreated paraffinic base oil was mixed with a hydrotreated naphthenic base oil under mechanical stirring conditions.

The hydrotreated paraffinic base oil feedstock compositions used in the following examples are referenced Para 1 and Para 2, Para 1 is a group I base oil (API category I Base oil) and Para 2 is a group II base oil (API category II Base oil). Para 1 and Para 2 are characterized in Table 1 below.

TABLE 1

| | Test Method | Para 1 | Para 2 |
|---|---|---|---|
| Viscosity @ 40° C., cSt | ASTM D445 | 113.3 | 109.1 |
| Viscosity @ 100° C., cSt | ASTM D445 | 12.2 | 12.24 |
| Viscosity Index | ASTM D2270 | 97 | 102.5 |
| Density @ 60° F. (15.56° C.), | ASTM D4052 | 0.8845 | 0.8728 |
| G/cC | | | |
| Density @ 60° F. (15.56° C.), | ASTM D287 | 28.5 | |
| °API | | | |
| Flash Point, Cleveland Open | ASTM D92 | 264 | 280 |
| Cup, ° C. | | | |
| Sulfur, PPM | ASTM D2622 | 3630 | 14 |
| Pour Point, ° C. | ASTM D5950 | −18 | −15 |
| Refractive Index @ 20° C. | ASTM D1218 | 1.4851 | 1.4782 |
| Color | ASTM D1500 | L1.5 | L0.5 |
| Aniline Point, ° C. | ASTM D611 | 114 | 125 |
| Viscosity-Gravity Constant | ASTM D2501 | 0.811 | 0.8 |
| Clay-Gel Analysis | ASTM D2007 | | |
| Saturates, Wt. % | | 74 | 94.1 |
| Aromatics, Wt. % | | 25 | 5.9 |
| Polars, Wt. % | 1 | 0.1 | |
| Distillation Data, ° F. | ASTM D2887 | | |
| 0.50% | | | |
| 5.00% | | 808 | 806 |
| 10.00% | | 855 | |
| 50.00% | | 944 | 969 |
| 90.00% | | 1018 | 1060 |
| 95.00% | | 1035 | |
| Tg, ° C. by DSC | ASTM E1356 | −68 | −68 |
| PNA's, Wt. % | IP346 | <3 | <3 |

The hydrotreated naphthenic base oil feedstock compositions used in the following examples are referenced Naph 1, Naph 2 and Naph 3. Naph 1, Naph 2 and Naph 3 are characterized in Table 2 below.

TABLE 2

| | Test Method | Naph 1 | Naph 2 | Naph 3 |
|---|---|---|---|---|
| Viscosity @ 40° C., | ASTM D445 | 227 | 386.00 | 524.78 |
| cSt | | | | |
| Viscosity @ | ASTM D445 | 15.6 | 16.70 | 20.605 |
| 100° C., cSt | | | | |
| Specific Gravity @ | ASTM D4052 | 0.91 | 0.9297 | 0.94 |
| 15.56° C. | | | | |
| Pour Point, ° C. | ASTM D5950 | −18 | −7 | −15 |
| Flash Point, | ASTM D92 | 256 | 246 | 244 |
| Cleveland Open | | | | |
| Cup, ° C. | | | | |
| Refractive Index @ | ASTM D1747 | 1.5147 | 1.5104 | 1.5104 |
| 20° C. | | | | |
| Color | ASTM D1500 | 1.5 | 1.5 | L2.0 |
| Aniline Point, ° C. | ASTM D611 | 108 | 86 | 87 |
| Clay Gel | ASTM D2007 | | | |
| Saturates, Wt. % | | 76.7 | 53.1 | 50.7 |
| Aromatics, Wt. % | | 18.4 | 44.6 | 46.4 |
| Polars, Wt. % | | 4.9 | 2.3 | 2.9 |
| Sulfur, ppm | ASTM D2622 | 1000 | 1810 | 1000 |
| Carbon Type | ASTM D2140 | | | |
| Distribution | | | | |
| % Cn | | 48 | 36 | 42 |
| (naphthenic carbon) | | | | |
| % Cp | | 39 | 51 | 50 |
| (paraffinic carbon) | | | | |
| % Ca | | 13 | 13 | 9 |
| (aromatic carbon) | | | | |
| Distillation | ASTM D2887 | | | |
| Data, ° C. | | | | |
| IBP | | 538 | 352 | 633 |
| 5% | | 668 | 394 | 712 |
| 95% | | 1040 | 533 | 1037 |
| FBP | | 1127 | 570 | 1115 |
| Tg, ° C. by DSC | ASTM E1356 | −59 | −48 | −50 |
| PNA's, Wt. % | IP346 | <3.0 | <3.0 | <3.0 |

In Example 1, 1400 g of Para 1 was blended with 600 g of Naph 2. The mixture was stirred mechanically at room temperature (25° C.) for 30 minutes.

In Example 2, 1400 g of Para 1 was blended with 600 g of Naph 1. The mixture was stirred mechanically at room temperature (25° C.) for 30 minutes.

In Example 3, 1000 g of Para 1 was blended with 1000 g of Naph 2. The mixture was stirred mechanically at 50° C. for 120 minutes.

In Example 4, 1500 g of Para 1 was blended with 500 g of Naph 3. The mixture was stirred mechanically at room temperature (25° C.) for 30 minutes.

In Example 5, 800 g of Para 2 was blended with 1200 g of Naph 2. The mixture was stirred mechanically at room temperature (25° C.) for 30 minutes.

In Example 6, 400 g of Para 2 was blended with 1600 g of Naph 2. The mixture was stirred mechanically at room temperature (25° C.) for 30 minutes.

The rubber extender oil composition produced in Examples 1 to 6 is characterized in Table 3 below.

TABLE 3

| | Test Method | Example 1 | Example 2 | Example 3 | Example 4 | Example 5 | Example 6 |
|---|---|---|---|---|---|---|---|
| Paraffinic base oil | | Para 1 | Para 1 | Para 1 | Para 1 | Para 2 | Para 2 |
| Napthenic base oil | | Naph 2 | Naph 1 | Naph 2 | Naph 3 | Naph 2 | Naph 2 |
| Ratio (wt. % Paraffinic:wt. % Naphthenic) | | 70:30 | 70:30 | 50:50 | 75:25 | 40:60 | 20:80 |
| Viscosity, cSt @ 40° C. | ASTM D445 | 148.1 | 138.8 | 183.3 | 149.5 | 200.5 | 268.8 |
| Viscosity, cSt @ 100° C. | ASTM D445 | 13.17 | 12.74 | 13.95 | 13.42 | 14.45 | 15.6 |
| SSU/100F | ASTM D2161 | 782.9 | 733.7 | 979.7 | 789.7 | 1075.5 | 1458.9 |
| SSU/210F | ASTM D2161 | 71.9 | 70.2 | 75.1 | 72.9 | 77.2 | 82 |
| VI | ASTM D2270 | 78.5 | 80.3 | 61.8 | 81.1 | 57 | 31 |
| Specific Gravity @ 15.56° C. | ASTM D4052 | 0.8993 | 0.8929 | 0.9098 | 0.897 | 0.9116 | 0.9246 |
| Flash Point (Cleveland Open Cup, ° C.) | ASTM D92 | 255 | 241 | 255 | 263 | 249 | 238 |
| Sulfur, PPM | ASTM D2622 | 3084 | 2841 | 2290 | 2000 | 1092 | 1451 |
| Pour Point, ° C. | ASTM D5950 | −12 | −9 | −18 | −12 | −28 | −19 |
| Refractive Index @ 20° C. | ASTM D1218 | 1.4944 | 1.4902 | 1.5000 | 1.4934 | 1.4995 | 1.5069 |
| Aniline Point, ° C. | ASTM D611 | 104 | 108 | 100 | 107 | 101 | 97 |
| Carbon Type Distribution | ASTM D2140 | | | | | | |
| % Cn (naphthenic carbon) | | 31.30 | 31.90 | 33.3 | 30.3 | 35.3 | 36.6 |
| % Cp (paraffinic carbon) | | 60.50 | 62.60 | 56.2 | 61.8 | 55.3 | 50.6 |
| % Ca (aromatic carbon) | | 8.20 | 5.50 | 10.5 | 7.9 | 9.4 | 12.8 |
| Clay-Gel Analysis | ASTM D2007 | | | | | | |
| Saturates, % Wt | | 65.0 | 71.2 | 57.1 | 66.4 | 68.3 | 61.1 |
| Aromatics, % Wt | | 33.4 | 27.7 | 41.0 | 32.4 | 30.1 | 36.8 |
| Polars, % Wt | | 1.6 | 1.1 | 1.9 | 1.2 | 1.6 | 2.1 |
| Distillation Data | ASTM D2887 | | | | | | |
| 5.00% | | 730 | 731 | 715 | 754 | 700 | 691 |
| 50.00% | | 940 | 945 | 924 | 946 | 899 | 873 |
| 95.00% | | 1048 | 1052 | 946 | 1050 | 1032 | 1030 |
| Tg, ° C. by DSC | ASTM E1356 | −64 | −61 | −55 | −63 | −63 | −60 |
| PNA's, Wt. % | IP346 | 1.0 | 0.4 | 1.5 | 0.9 | 2.0 | 2.5 |

1. A process for the preparation of a rubber extender oil composition having a polynuclear aromatics content of at most 3 wt. %, comprising blending a hydrotreated paraffinic base oil having a polynuclear aromatics content of at most 3 wt. % and a hydrotreated naphthenic base oil having a polynuclear aromatics content of at most 3 wt. %.

2. The process of claim 1 wherein the rubber extender oil product composition has an aromatic content of at least about 25 wt. %.

3. The process of claim 2 wherein the rubber extender oil product composition has an aromatic content of at least about 30 wt. %.

4. The process of claim 1 wherein the rubber extender oil product composition has an aniline point in the range of from about 90 to about 110° C.

5. The process of claim 1 wherein the rubber extender oil product composition has a glass transition point in the range of from −70 to −20° C.

6. The process of claim 1 wherein the rubber extender oil product composition has a viscosity in the range of from about 12 to about 17 cSt at 100° C.

7. The process of claim 1 wherein the rubber extender oil product composition has a flash point of at least 240° C.

8. The process of claim 1 wherein the rubber extender oil product composition has a flash point in the range of from 240 to 275° C.

9. The process of claim 1 wherein the rubber extender oil product composition has a pour point of about −8° C. or lower.

10. The process of claim 4 wherein the rubber extender oil product composition has a glass transition point in the range of from −70 to −20° C.

11. The process of claim 1 wherein the blending of the hydrotreated paraffinic base oil and the hydrotreated naphthenic base oil is performed using a mechanical stirring method.

12. The process of claim 1 wherein the blending of the hydrotreated paraffinic base oil and the hydrotreated naphthenic base oil is performed in-situ during the preparation of the rubber composition.

13. The process of claim 1 wherein the blending of the hydrotreated paraffinic base oil and the hydrotreated naphthenic base oil is performed at a temperature in the range of from 0° C. to 200° C.

14. The process of claim 1 wherein the blending of the hydrotreated paraffinic base oil and the hydrotreated naphthenic base oil is performed at a pressure in the range of from 0 atm to 100 atm.

15. The process of claim 1 wherein the blending of the hydrotreated paraffinic base oil and the hydrotreated naphthenic base oil is performed at room temperature.

16. The process of claim 1 wherein the blending of the hydrotreated paraffinic base oil and the hydrotreated naphthenic base oil is performed at atmospheric pressure.

17. A process for the preparation of a rubber extender oil composition having a polynuclear aromatics content of at most 3 wt. %, an aromatic content of at least about 25 wt. %, an aniline point in the range of from about 90 to about 110° C., a glass transition point in the range of from −70 to −20° C., and a viscosity in the range of from about 12 to about 17 cSt at 100° C., comprising blending a hydrotreated paraffinic base oil having a polynuclear aromatics content of at most 3 wt. % and a hydrotreated naphthenic base oil having a polynuclear aromatics content of at most 3 wt. %.

18. The process of claim 17 wherein the rubber extender oil product composition has a flash point of at least 240° C.

19. The process of claim 17 wherein the rubber extender oil product composition has a flash point in the range of from 240 to 275° C.

20. The process of claim 17 wherein the rubber extender oil product composition has a pour point of about −8° C. or lower.

21. The process of claim 17 wherein the blending of the hydrotreated paraffinic base oil and the hydrotreated naphthenic base oil is performed using a mechanical stirring method.

22. The process of claim 17 wherein the blending of the hydrotreated paraffinic base oil and the hydrotreated naphthenic base oil is performed in-situ during the preparation of the rubber composition.

23. The process of claim 17 wherein the blending of the hydrotreated paraffinic base oil and the hydrotreated naphthenic base oil is performed at a temperature in the range of from 0° C. to 200° C.

24. The process of claim 17 wherein the blending of the hydrotreated paraffinic base oil and the hydrotreated naphthenic base oil is performed at a pressure in the range of from 0 atm to 100 atm.

25. The process of claim 17 wherein the blending of the hydrotreated paraffinic base oil and the hydrotreated naphthenic base oil is performed at room temperature.

26. The process of claim 17 wherein the blending of the hydrotreated paraffinic base oil and the hydrotreated naphthenic base oil is performed at atmospheric pressure.

27. A process for the preparation of a rubber extender oil composition having a polynuclear aromatics content of at most 3 wt. %, comprising blending a hydrotreated paraffinic base oil having a polynuclear aromatics content of at most 3 wt. % and a hydrotreated naphthenic base oil having a polynuclear aromatics content of at most 3 wt. % in a ratio of from 1:20 to 20:1 by weight.

28. The process of claim 27 wherein the rubber extender oil product composition has an aromatic content of at least about 25 wt. %.

29. The process of claim 28 wherein the rubber extender oil product composition has an aromatic content of at least about 30 wt. %.

30. The process of claim 27 wherein the rubber extender oil product composition has an aniline point in the range of from about 90 to about 110° C.

31. The process of claim 27 wherein the rubber extender oil product composition has a glass transition point in the range of from −70 to −20° C.

32. The process of claim 27 wherein the rubber extender oil product composition has a viscosity in the range of from about 12 to about 17 cSt at 100° C.

33. The process of claim 30 wherein the rubber extender oil product composition has a flash point in the range of from 240 to 275° C.

34. The process of claim 27 wherein the rubber extender oil product composition has a flash point of at least 240° C.

35. The process of claim 27 wherein the rubber extender oil product composition has a flash point in the range of from 240 to 275° C.

36. The process of claim 27 wherein the rubber extender oil product composition has a pour point of at least about −8° C. or lower.

37. The process of claim 27 wherein the hydrotreated paraffinic base oil and the hydrotreated naphthenic base oil is blended in a ratio in the range of from 1:1 to 1:19 by weight.

38. The process of claim 28 wherein the hydrotreated paraffinic base oil and the hydrotreated naphthenic base oil is blended in a ratio in the range of from 1:1 to 1:19 by weight.

39. The process of claim 30 wherein the hydrotreated paraffinic base oil and the hydrotreated naphthenic base oil is blended in a ratio in the range of from 1:1 to 1:19 by weight.

40. The process of claim 31 wherein the hydrotreated paraffinic base oil and the hydrotreated naphthenic base oil is blended in a ratio in the range of from 1:1 to 1:19 by weight.

41. The process of claim 32 wherein the hydrotreated paraffinic base oil and the hydrotreated naphthenic base oil is blended in a ratio in the range of from 0.1:1 to 1:19 by weight.

42. The process of claim 27 wherein the blending of the hydrotreated paraffinic base oil and the hydrotreated naphthenic base oil is performed using a mechanical stirring method.

43. The process of claim 27 wherein the blending of the hydrotreated paraffinic base oil and the hydrotreated naphthenic base oil is performed in-situ during the preparation of the rubber composition.

44. The process of claim 27 wherein the blending of the hydrotreated paraffinic base oil and the hydrotreated naphthenic base oil is performed at a temperature in the range of from 0° C. to 200° C.

45. The process of claim 27 wherein the blending of the hydrotreated paraffinic base oil and the hydrotreated naphthenic base oil is performed at a pressure in the range of from 0 atm to 100 atm.

46. The process of claim 27 wherein the blending of the hydrotreated paraffinic base oil and the hydrotreated naphthenic base oil is performed at room temperature.

47. The process of claim 27 wherein the blending of the hydrotreated paraffinic base oil and the hydrotreated naphthenic base oil is performed at atmospheric pressure.

48. A process for the preparation of a rubber extender oil composition having a polynuclear aromatics content of at most 3 wt. %, an aromatic content of at least about 25 wt. %, an aniline point in the range of from about 90 to about 110° C., a glass transition point in the range of from −70 to −20° C., and a viscosity in the range of from about 12 to about 17 cSt at 100° C., comprising blending a hydrotreated paraffinic base oil having a polynuclear aromatics content of at most 3 wt. % and a hydrotreated naphthenic base oil having a polynuclear aromatics content of at most 3 wt. % in a ratio in the range of from 1:20 to 20:1 by weight.

49. The process of claim 48 wherein the rubber extender oil product composition has a flash point of at least 240° C.

50. The process of claim 48 wherein the rubber extender oil product composition has a flash point in the range of from 240 to 275° C.

51. The process of claim 48 wherein the rubber extender oil product composition has a pour point of about −8° C. or lower.

52. The process of claim 48 wherein the hydrotreated paraffinic base oil and the hydrotreated naphthenic base oil is blended in a ratio in the range of from 1:1 to 1:19 by weight.

53. The process of claim 52 wherein the rubber extender oil product composition has an aromatic content of at least about 30 wt. %.

54. The process of claim 48 wherein the blending of the hydrotreated paraffinic base oil and the hydrotreated naphthenic base oil is performed using a mechanical stirring method.

55. The process of claim 48 wherein the blending of the hydrotreated paraffinic base oil and the hydrotreated naphthenic base oil is performed in-situ during the preparation of the rubber composition.

56. The process of claim 48 wherein the blending of the hydrotreated paraffinic base oil and the hydrotreated naphthenic base oil is performed at a temperature in the range of from 0° C. to 200° C.

57. The process of claim 48 wherein the blending of the hydrotreated paraffinic base oil and the hydrotreated naphthenic base oil is performed at a pressure in the range of from 0 atm to 100 atm.

58. The process of claim 48 wherein the blending of the hydrotreated paraffinic base oil and the hydrotreated naphthenic base oil is performed at room temperature.

59. The process of claim 48 wherein the blending of the hydrotreated paraffinic base oil and the hydrotreated naphthenic base oil is performed at atmospheric pressure.

60. A process for the preparation of a rubber extender oil composition having a polynuclear aromatics content of at most 3 wt. %, comprising blending a hydrotreated paraffinic base oil having a polynuclear aromatics content of at most 3 wt. % and a hydrotreated naphthenic base oil having a polynuclear aromatics content of at most 3 wt. %, wherein the flash point of the hydrotreated paraffinic base oil is at least 235° C.

61. The process of claim 60 wherein the flash point of the hydrotreated paraffinic base oil is at least 240° C.

62. The process of claim 60 wherein the hydrotreated paraffinic base oil has an aromatic content of at least about 5 wt.

63. The process of claim 60 wherein the hydrotreated paraffinic base oil has an aniline point of at most about 130° C.

64. The process of claim 60 wherein the hydrotreated paraffinic base oil has an aniline point of at most about 125° C.

65. The process of claim 60 wherein the hydrotreated paraffinic base oil has a viscosity of at least about 11.0 cSt at 100° C.

66. The process of claim 60 wherein the hydrotreated paraffinic base oil has a viscosity of at least about 11.5 cSt at 100° C.

67. The process of claim 60 wherein the hydrotreated paraffinic base oil has a viscosity of at least about 100 cSt at 40° C.

68. A process for the preparation of a rubber extender oil composition having a polynuclear aromatics content of at most 3 wt. %, comprising blending a hydrotreated paraffinic base oil having a polynuclear aromatics content of at most 3 wt. % and a hydrotreated naphthenic base oil having a polynuclear aromatics content of at most 3 wt. %, wherein the hydrotreated paraffinic base oil has an aromatic content of at least 5 wt. %, an aniline point of at most 130° C. and a viscosity of at least 11.0 cSt at 100° C.

69. A process for the preparation of a rubber extender oil composition having a polynuclear aromatics content of at most 3 wt. %, comprising blending a hydrotreated paraffinic base oil having a polynuclear aromatics content of at most 3 wt. % and a hydrotreated naphthenic base oil having a polynuclear aromatics content of at most 3 wt. %, wherein the flash point of the hydrotreated naphthenic base oil is at least 235° C.

70. The process of claim 69 wherein the flash point of the hydrotreated naphthenic base oil is at least 240° C.

71. The process of claim 70 wherein the hydrotreated naphthenic base oil has a viscosity of at least about 15 cSt at 100° C.

72. The process of claim 69 wherein the hydrotreated naphthenic base oil has an aniline point of at most about 110° C.

73. A process for the preparation of a rubber extender oil composition having a polynuclear aromatics content of at most 3 wt. %, comprising blending a hydrotreated paraffinic base oil having a polynuclear aromatics content of at most 3 wt. % and a hydrotreated naphthenic base oil having a polynuclear aromatics content of at most 3 wt. %, wherein the hydrotreated naphthenic base oil has a flash point of at least 240° C., a viscosity of at least 15 cSt at 100° C., and an aniline point of at most 110° C.

74. A process for the preparation of a rubber extender oil composition having a polynuclear aromatics content of at most 3 wt. %, comprising blending a hydrotreated paraffinic base oil having a polynuclear aromatics content of at most 3 wt. % and a hydrotreated naphthenic base oil having a polynuclear aromatics content of at most 3 wt. %, wherein the hydrotreated paraffinic base oil has an aromatic content of at least 5 wt. %, an aniline point of at most 130° C. and a viscosity of at least 11.0 cSt at 100° C., and wherein the hydrotreated naphthenic base oil has a flash point of at least 240° C., a viscosity of at least 15 cSt at 100° C., and an aniline point of at most 110° C.

75. The process of claim 74 wherein the blending of the hydrotreated paraffinic base oil and the hydrotreated naphthenic base oil is performed using a mechanical stirring method.

76. The process of claim 74 wherein the hydrotreated paraffinic base oil and the hydrotreated naphthenic base oil are blended in a ratio in the range of from 1:20 to 20:1.

77. The process of claim 76 wherein the hydrotreated paraffinic base oil and the hydrotreated naphthenic base oil are blended in a ratio in the range of from 1:1 to 1:19.

78. A process for the preparation of a process oil useful as a rubber extender oil composition having a polynuclear aromatics content of at most 3 wt. %, an aromatic content of at least about 30 wt. %, an aniline point in the range of from about 90 to about 110° C., a glass transition point in the range of from −70 to −20° C., a viscosity in the range of from about 12 to about 17 cSt at 100° C., a flash point in the range of from 240 to 275° C. and a pour point of about −8° C. or lower, comprising blending a hydrotreated paraffinic base oil having a polynuclear aromatics content of at most 3 wt. % and a hydrotreated naphthenic base oil having a polynuclear aromatics content of at most 3 wt. %, wherein the hydrotreated naphthenic base oil has a flash point of at least 240° C., a viscosity of at least 15 cSt at 100° C., and an aniline point of at most 110° C.

79. A process for the preparation of a process oil useful as a rubber extender oil composition having a polynuclear aromatics content of at most 3 wt. %, an aromatic content of at least about 30 wt. %, an aniline point in the range of from about 90 to about 110° C., a glass transition point in the range of from −70 to −20° C., a viscosity in the range of from about 12 to about 17 cSt at 100° C., a flash point in the range of from 240 to 275° C. and a pour point of about −8° C. or lower, comprising blending a hydrotreated paraffinic base oil having a polynuclear aromatics content of at most 3 wt. % and a hydrotreated naphthenic base oil having a polynuclear aromatics content of at most 3 wt. %, wherein the hydrotreated paraffinic base oil has an aromatic content of at least 5 wt. %, an aniline point of at most 130° C. and a viscosity of at least 11.0 cSt at 100° C., and the hydrotreated naphthenic base oil has a flash point of at least 240° C., a viscosity of at least 15 cSt at 100° C., and an aniline point of at most 110° C.

80. The process of claim 79 wherein the blending of the hydrotreated paraffinic base oil and the hydrotreated naphthenic base oil is performed using a mechanical stirring method.

81. The process of claim 81 wherein the hydrotreated paraffinic base oil and the hydrotreated naphthenic base oil are blended in a ratio in the range of from 1:20 to 20:1.

82. A rubber composition comprising:
a) at least one rubber, rubber component, or mixtures thereof, and
b) a rubber extender oil composition produced by the process of claim 1 in the range of from 0.5 wt. % to 50 wt. % based on the weight of the rubber composition.

83. The rubber composition of claim 82 wherein the rubber extender oil composition is produced by blending of the hydrotreated paraffinic base oil and the hydrotreated naphthenic base oil in-situ during the preparation of the rubber composition.

84. The rubber composition of claim 82 wherein the blending of the components of the rubber composition occurs in any order.

85. A rubber composition comprising:
a) at least one rubber, rubber component, or mixtures thereof, and
b) a rubber extender oil composition produced by the process of claim 17 in the range of from 0.5 wt. % to 50 wt. % based on the weight of the rubber composition.

86. The rubber composition of claim 85 wherein the rubber extender oil composition is produced by blending of the hydrotreated paraffinic base oil and the hydrotreated naphthenic base oil in-situ during the preparation of the rubber composition.

87. The rubber composition of claim 85 wherein the blending of the components of the rubber composition occurs in any order.

88. A rubber composition comprising:
a) at least one rubber, rubber component, or mixtures thereof, and
b) a rubber extender oil composition produced by the process of claim 27 in the range of from 0.5 wt. % to 50 wt. % based on the weight of the rubber composition.

89. The rubber composition of claim 88 wherein the rubber extender oil composition is produced by blending of the hydrotreated paraffinic base oil and the hydrotreated naphthenic base oil in-situ during the preparation of the rubber composition.

90. The rubber composition of claim 88 wherein the blending of the components of the rubber composition occurs in any order.

91. A rubber composition comprising:
a) at least one rubber, rubber component, or mixtures thereof, and
b) a rubber extender oil composition produced by the process of claim 48 in the range of from 0.5 wt. % to 50 wt. % based on the weight of the rubber composition.

92. The rubber composition of claim 91 wherein the rubber extender oil composition is produced by blending of the hydrotreated paraffinic base oil and the hydrotreated naphthenic base oil in-situ during the preparation of the rubber composition.

93. The rubber composition of claim 91 wherein the blending of the components of the rubber composition occurs in any order.

94. A rubber composition comprising:
a) at least one rubber, rubber component, or mixtures thereof,
b) a rubber extender oil composition produced by the process of claim 1 in the range of from 0.5 wt. % to 50 wt. % based on the weight of the rubber composition, and optionally at least one component selected from:
c) reinforcing agents,
d) cross-linking agents and/or cross-linking auxiliaries,
e) inorganic fillers, and
f) waxes and/or antioxidants.

95. The rubber composition of claim 94 wherein the rubber extender oil composition is produced by blending of the hydrotreated paraffinic base oil and the hydrotreated naphthenic base oil in-situ during the preparation of the rubber composition.

96. The rubber composition of claim 94 wherein the rubber extender oil composition is incorporated in the range of from 5 wt. % to 40 wt. % based on the weight of the rubber composition.

97. The rubber composition of claim 94 wherein the rubber, rubber component, or mixtures thereof, is synthetic rubber.

98. The rubber composition of claim 94 wherein the rubber, rubber component, or mixtures thereof, is natural rubber.

99. The rubber composition of claim 94 wherein the rubber, rubber component, or mixtures thereof, is a mixture of synthetic and natural rubber.

100. The rubber composition of claim 94 wherein the rubber, rubber component, or mixtures thereof, is a styrene-butadiene copolymer.

101. A rubber composition comprising:
a) at least one rubber, rubber component, or mixtures thereof,
b) a rubber extender oil composition produced by the process of claim 17 in the range of from 0.5 wt. % to 50 wt. % based on the weight of the rubber composition, and optionally at least one component selected from:
c) reinforcing agents,
d) cross-linking agents and/or cross-linking auxiliaries,
e) inorganic fillers, and
f) waxes and/or antioxidants.

102. The rubber composition of claim 101 wherein the rubber extender oil composition is produced by blending of the hydrotreated paraffinic base oil and the hydrotreated naphthenic base oil in-situ during the preparation of the rubber composition.

103. The rubber composition of claim 101 wherein the rubber extender oil composition is incorporated in the range of from 5 wt. % to 40 wt. % based on the weight of the rubber composition.

104. The rubber composition of claim 101 wherein the rubber, rubber component, or mixtures thereof, is synthetic rubber.

105. The rubber composition of claim 101 wherein the rubber, rubber component, or mixtures thereof, is natural rubber.

106. The rubber composition of claim 101 wherein the rubber, rubber component, or mixtures thereof, is a mixture of synthetic and natural rubber.

107. The rubber composition of claim 101 wherein the rubber, rubber component, or mixtures thereof, is a styrene-butadiene copolymer.

108. A rubber composition comprising:
a) at least one rubber, rubber component, or mixtures thereof,
b) a rubber extender oil composition produced by the process of claim 27 in the range of from 0.5 wt. % to 50 wt. % based on the weight of the rubber composition, and optionally at least one component selected from:
c) reinforcing agents,
d) cross-linking agents and/or cross-linking auxiliaries,
e) inorganic fillers, and
f) waxes and/or antioxidants.

109. The rubber composition of claim 108 wherein the rubber extender oil composition is produced by blending of the hydrotreated paraffinic base oil and the hydrotreated naphthenic base oil in-situ during the preparation of the rubber composition.

110. The rubber composition of claim 108 wherein the rubber extender oil composition is incorporated in the range of from 5 wt. % to 40 wt. % based on the weight of the rubber composition.

111. The rubber composition of claim 108 wherein the rubber, rubber component, or mixtures thereof, is synthetic rubber.

112. The rubber composition of claim 108 wherein the rubber, rubber component, or mixtures thereof, is natural rubber.

113. The rubber composition of claim 108 wherein the rubber, rubber component, or mixtures thereof, is a mixture of synthetic and natural rubber.

114. The rubber composition of claim 109 wherein the rubber, rubber component, or mixtures thereof, is a styrene-butadiene copolymer.

115. A method of making or compounding a rubber composition comprising mixing a rubber extender oil composition produced by the process of claim 1 with at least one rubber or rubber compound.

116. The method of making or compounding a rubber composition of claim 115 wherein said rubber extender oil composition is prepared in-situ during the preparation of the rubber composition.

117. The method of making or compounding a rubber composition of claim 115 wherein the rubber or rubber compound is in a crumb, pellet and/or powder form.

118. The method of making or compounding a rubber composition of claim 116 wherein the rubber or rubber compound is in a crumb, pellet and/or powder form.

119. The method of making or compounding a rubber composition of claim 115 wherein the rubber extender oil composition is added to the rubber or rubber compound when it is being ground.

120. The method of making or compounding a rubber composition of claim 115 wherein the rubber extender oil composition is added to the rubber or rubber compound when it is being ground, and the rubber extender oil composition is prepared in-situ whilst the rubber or rubber compound is being ground.

121. A method of making or compounding a rubber composition comprising mixing a rubber extender oil composition produced by the process of claim 1 with one or more monomer precursors of a rubber or a rubber compound.

122. The method of making or compounding a rubber composition comprising of claim 121 wherein the rubber extender oil composition is prepared in-situ in the monomer mix before it is polymerized into the rubber composition.

123. A method of making or compounding a rubber composition comprising mixing a rubber extender oil composition produced by the process of claim 17 with at least one rubber or rubber compound.

124. The method of making or compounding a rubber composition of claim 123 wherein said rubber extender oil composition is prepared in-situ during the preparation of the rubber composition.

125. The method of making or compounding a rubber composition of claim 123 wherein the rubber or rubber compound is in a crumb, pellet and/or powder form.

126. The method of making or compounding a rubber composition of claim 124 wherein the rubber or rubber compound is in a crumb, pellet and/or powder form.

127. The method of making or compounding a rubber composition of claim 123 wherein the rubber extender oil composition is added to the rubber or rubber compound when it is being ground.

128. The method of making or compounding a rubber composition of claim 123 wherein the rubber extender oil composition is added to the rubber or rubber compound when it is being ground, and the rubber extender oil composition is prepared in-situ whilst the rubber or rubber compound is being ground.

129. A method of making or compounding a rubber composition comprising mixing a rubber extender oil composition produced by the process of claim 17 with one or more monomer precursors of a rubber or rubber compound.

130. The method of making or compounding a rubber composition comprising of claim 129 wherein the rubber extender oil composition is prepared in-situ in the monomer mix before it is polymerized into the rubber composition.
